(19) United States
(12) Patent Application Publication
(10) Pub. No.: US 2011/0261367 A1
(43) Pub. Date: Oct. 27, 2011

(54) Integrated Confocal and Spectral-Domain Optical Coherence Tomography Microscope

(76) Inventors: Arthur F. Gmitro, Tucson, AZ (US); Houssine Makhlouf, Tucson, AZ (US)

(21) Appl. No.: 13/092,738

(22) Filed: Apr. 22, 2011

Related U.S. Application Data
(60) Provisional application No. 61/343,119, filed on Apr. 23, 2010.

(30) Foreign Application Priority Data
Apr. 23, 2010 (WO) 2010/126790

(51) Int. Cl. G01B 9/02

(52) U.S. Cl. 356/479

(57) ABSTRACT

Confocal microscopy and optical coherence tomography (OCT) are two components combined in a system using the same optical train that have significant potential applications, such as for real-time in situ view of tissue in a clinical setting. Preferably the two methods employ wavelength ranges that are different, and more preferably non-overlapping, allowing rapid switching between the two imaging techniques. The system illuminates multiple points of a sample and provides outputs indicative of sample properties at the multiple points simultaneously for confocal microscopy and OCT. When used in an endoscope, an optical fiber bundle inserted in an animal body is used to transmit light from the system to tissue and collect return light and deliver the return light for confocal microscopy and OCT imaging.

### CROSS-REFERENCE TO RELATED APPLICATION

This application claims priority to and receives the benefit of U.S. Provisional Patent Application No. 61/343,119 filed Apr. 23, 2010, which application is incorporated herein in its entirety by this reference. This application is also a continuation-in-part application of PCT Publication No. WO 2010/126790, filed Apr. 23, 2010 and published Nov. 4, 2010, which claims priority to and receives the benefit of U.S. Provisional Patent Application No. 61/214,703 filed on Apr. 27, 2009. All applications mentioned above are incorporated herein in their entirety by this reference.

### GOVERNMENT RIGHTS

This invention was made with government support under NIH; R01 CA115780 awarded by The National Institutes of Health. The government has certain rights in the invention.

### BACKGROUND OF THE INVENTION

There is a critical need for screening methods to detect and diagnose early-stage disease. In ovarian cancer, for example, the 5-year survival rate is over 90% when the disease is diagnosed early at a localized stage, whereas the 5-year survival rate drops to less than 30% when the cancer has spread beyond the ovary. Unfortunately only 15% of all ovarian cancers are diagnosed when the disease is still in its early stage (see, National Cancer Institute, “Surveillance Epidemiology and End Results Stat Fact Sheets: Ovary” (2010), http://seer.cancer.gov/statfacts/html/ovary.html#survival). Similar situations are encountered in other diseases, where early diagnosis generally equates to a much improved prognosis.

Various methods of “optical biopsy” have been developed to address the need for rapid in situ diagnosis of disease. Confocal microendoscopy is one such method in which a dedicated instrument allows confocal microscopic imaging of living tissue inside the body. Depending on the system architecture, the signal of interest can be fluorescence emission (see, A. A. Tanbakuchi, A. R. Rouse, J. A. Udovich, K. D. Hatch, and A. F. Gmitro, “Clinical confocal microlaparoscope for real-time in vivo optical biopsies,” J. Biomed. Opt. 14(4), 044030 (2009); P. S. P. Thong, M. Olivo, K. W. Kho, W. Zheng, K. Mancer, M. Harris, and K. C. Soo, “Laser confocal endomicroscopy as a novel technique for fluorescence diagnostic imaging of the oral cavity,” J. Biomed. Opt. 12(1), 014007 (2007); and R. Kiesslich, J. Burg, M. Vieth, J. Gnaendiger, M. Enders, P. Delaney, A. Polglase, W. McLaren, D. Janell, S. Thomas, B. Nafe, P. R. Galle, and M. F. Neurath, “Confocal laser endoscopy for diagnosing intraepithelial neoplasias and colorectal cancer in vivo,” Gastroenterology 127(3), 706-713 (2004)) or reflected light (see, K. Carlson, M. Chidley, K. B. Sung, M. Descour, A. Gillenwater, M. Follett, and R. Richards-Kortum, “In vivo fiber-optic confocal reflectance microscope with an injection-molded plastic miniature objective lens,” Appl. Opt. 44(10), 1792-1797 (2005)). In both cases the collected signal is spatially filtered by a confocal aperture to reject light coming from out-of-focus planes so that a high quality image of a thin optical section within a thick tissue is obtained.

A variety of confocal microendoscope implementations have been demonstrated including the use of a fiber bundle to relay the image plane of confocal microscope to the remote tissue site (see, A. F. Gmitro and D. Aziz, “Confocal microscopy through a fiber-optic imaging bundle,” Opt. Lett. 18(8), 565-567 (1993)), a miniature scanning confocal microscope in the distal tip of a catheter (see, H. J. Shin, M. C. Pierce, D. Lee, H. Ra, O. Solgaard, and R. Richards-Kortum, “Fiber-optic confocal microscope using a MEMS scanner and miniature objective lens,” Opt. Express 15(15), 9113-9122 (2007)), and spectral encoding to achieve spatial scanning (see, G. J. Teamey, R. H. Webb, and B. E. Bouma, “Spectrally encoded confocal microscopy,” Opt. Lett. 23(15), 1152-1154 (1998)). Commercial confocal microendoscope systems are now available and being used in a number of clinical applications.

Optical coherence tomography (OCT) is another important optical biopsy technique. OCT is a depth-resolved imaging method based on low-coherence light interferometry. In OCT, a near infrared light source with a relatively broad spectral bandwidth is split into two channels of an interferometer. One channel directs light to the biological tissue and the other channel acts as a reference. When the optical path lengths of the two channels match within the coherence length of the source, an interference signal is generated. OCT imaging is implemented using one of two major techniques referred to as time-domain OCT (TD-OCT) (see, J. A. Izatt, M. D. Kulkarni, H.-W. Wang, K. Kobayashi, and M. V. Sivak, “Optical coherence tomography and microscopy in gastrointestinal tissues,” IEEE J. Sel. Top. Quantum Electron. 2(4), 1017-1028 (1996)) and spectral-domain OCT (SD-OCT) (see, M. Wojtkowski, R. Leitgeb, A. Kowalczyk, T. Bajraszewski, and A. F. Fercher, “In vivo human retinal imaging by Fourier domain optical coherence tomography,” J. Biomed. Opt. 7(3), 457-463 (2002)).

In TD-OCT the reference mirror is scanned in time to alter the path length in the reference channel. The resulting interference signal as a function of time relates to the matching path length (depth) in the tissue from where the light is back scattered. In SD-OCT, the reference reflector is fixed and the combined interfering light is dispersed through a diffraction grating or other dispersive element onto a one dimensional detector array. Each modulation frequency of constructive and destructive interference on the detector corresponds to a particular depth of backscatter in the tissue. A Fourier transform of the spectral data recovers the depth distribution of backscatters in the sample. SD-OCT and TD-OCT systems typically use a point of illumination and produce a one-dimensional depth scan (A-scan) of the backscattered light signal as a function of depth below a single point on the tissue surface. Scanning the illumination point across the tissue in one direction generates a 2D cross-sectional image of the sample (B-scan). This 2D cross-sectional view is comparable to the orientation of most histology slide preparations (see, V. R. Korde, G. T. Bonnema, W. Xu, C. Krishnamurthy, J. Ranger-Moore, K. Saboda, L. D. Slayton, S. J. Salasche, J. A. Warneke, D. S. Alberts, and J. K. Barton, “Using optical coherence tomography to evaluate skin sun damage and precancer,” Lasers Surg. Med. 39(9), 687-695 (2007)). A full 3D image of the sample can be acquired by raster scanning the OCT illumination across the surface of the tissue.

Fluorescence confocal imaging and OCT imaging complement each other in that they are based on different contrast mechanisms and show different structural features of biological tissues. Fluorescence confocal systems yield high resolution en face images that can easily depict cellular morphology and can often reveal sub-cellular structures, especially when used with exogenous fluorophores. However, confocal systems have limited imaging depth due to the highly scattering nature of biological tissues. OCT imaging is often done at somewhat courser lateral resolution but can image deeper into tissue due to the better penetration of infrared light and the high dynamic range of the coherence gating technique. This allows one to detect morphological changes occurring deeper inside tissues.

The combination of separate confocal and OCT systems to provide complementary information about a tissue sample was recently reported (see, D. Kang, M. J. Suter, C. Boudoux, P. S. Yachimski, B. E. Bouma, N. S. Nishioka, and G. J. Tearney, “Combined spectrally encoded confocal microscopy and optical frequency domain imaging system,” Proc. SPIE 7172, 717206, 717206-7 (2009)). Rogers et al., in U.S. Pat. No. 7,649,629, describe a combined confocal microscope and optical coherence tomographic instrument for ophthalmic applications. The above instruments, however, cannot conveniently be used in an endoscope for in vivo optical biopsies. These instruments also are single point imaging systems, so that much time may be required to acquire an image with many image pixels. It is therefore desirable to provide an improved instrument with both confocal microscopy and optical coherence tomography capabilities that overcomes the above indicated short comings.

### SUMMARY OF THE INVENTION

One embodiment of the invention is directed to an endoscope obtaining confocal microscopic and optical coherence tomographic images from an object, comprising a confocal microscope, an optical coherence tomography instrument including a common-path interferometer; and a fiber bundle delivering to the object illumination light from the confocal microscope and the optical coherence tomography instrument, and collecting return light from the object and delivering the return light to the confocal microscope and the optical coherence tomography instrument.

Another embodiment of the invention is directed to a system performing confocal microscopic and optical coherence tomographic functions, comprising a confocal microscope including a first light source that provides light within a first wavelength range and an optical coherence tomography instrument including a second light source that provides light within a second wavelength range, wherein the first and second wavelength ranges are different; wherein the confocal microscope and the optical coherence tomography instrument share one or more optical elements whose optical characteristics are different in the first and second wavelength ranges.

Yet another embodiment of the invention is directed to a system obtaining confocal microscopic and optical coherence tomographic images from a sample, comprising a confocal microscope that illuminates multiple points of the sample and provides outputs indicative of sample properties at the multiple points simultaneously; and an optical coherence tomography instrument that illuminates multiple points of the sample and provides outputs indicative of sample properties at the multiple points simultaneously. The confocal microscope scans at least one illumination beam for illuminating multiple points of the sample and providing a two dimensional image from a selected depth in the object. The optical coherence tomography instrument illuminates multiple points of the sample and provides a two-dimensional cross sectional optical coherence tomography image without scanning.

One more embodiment of the invention is directed to a method for obtaining confocal microscopic and optical coherence tomographic images, using a confocal microscope and an optical coherence tomography instrument each of which illuminates multiple points of a sample and provides outputs indicative of sample properties at the multiple points simultaneously. The method comprises the following steps. The confocal microscope is used to scan at least one illumination beam for illuminating multiple points of the sample and providing a two dimensional image from a selected depth in the object. The optical coherence tomography instrument is used to scan at least one illumination beam for illuminating multiple points of the sample and providing a two dimensional optical coherence microscopy image from the selected depth in the object or a three-dimensional optical coherence tomography image over the volume. The two dimensional confocal microscopy and optical coherence microscopy images are compared or correlated.

Yet one more embodiment of the invention is directed to a method for obtaining confocal microscopic and optical coherence tomographic images of an object, using a confocal microscope, an optical coherence tomography instrument and a fiber bundle having a distal end and a proximal end, the fiber bundle delivering to the object at its distal end illumination light from the confocal microscope and the optical coherence tomography instrument, and collecting return light from the object and delivering the return light to the confocal microscope and the optical coherence tomography instrument at its proximal end. The method comprises the following steps. The distal end of the fiber bundle is inserted into an animal body, such as a human body. A two dimensional image is acquired from a selected depth in the animal body using the confocal microscope. A two-dimensional en face optical coherence microscopy image or a two-dimensional cross-sectional optical coherence tomography image is acquired from the animal body using the optical coherence tomography instrument.

All patents, patent applications, articles, books, specifications, other publications, documents and things referenced herein are hereby incorporated herein by this reference in their entirety for all purposes. To the extent of any inconsistency or conflict in the definition or use of a term between any of the incorporated publications, documents or things and the text of the present document, the definition or use of the term in the present document shall prevail.

### BRIEF DESCRIPTION OF THE DRAWINGS

FIG. 1 is a schematic view of a multispectral fluorescence confocal microendoscope to illustrate an embodiment of the invention.

FIG. 2 is a schematic view of a combined multi-spectral fluorescence confocal and SD-OCT imaging system to illustrate another embodiment of the invention.

FIG. 3 is a schematic view of a portion of the distal end of an optical fiber bundle in FIG. 2.

FIG. 4A is a schematic view of a multi-point scanning system employing a stationary confocal aperture array to illustrate yet another alternative embodiment of the invention.

FIG. 4B is a schematic view of the rotating star aperture that with the slit aperture creates multiple illumination points and collection apertures along a line.

For simplicity in description, identical components are labeled by the same numerals in this application.

### DETAILED DESCRIPTION

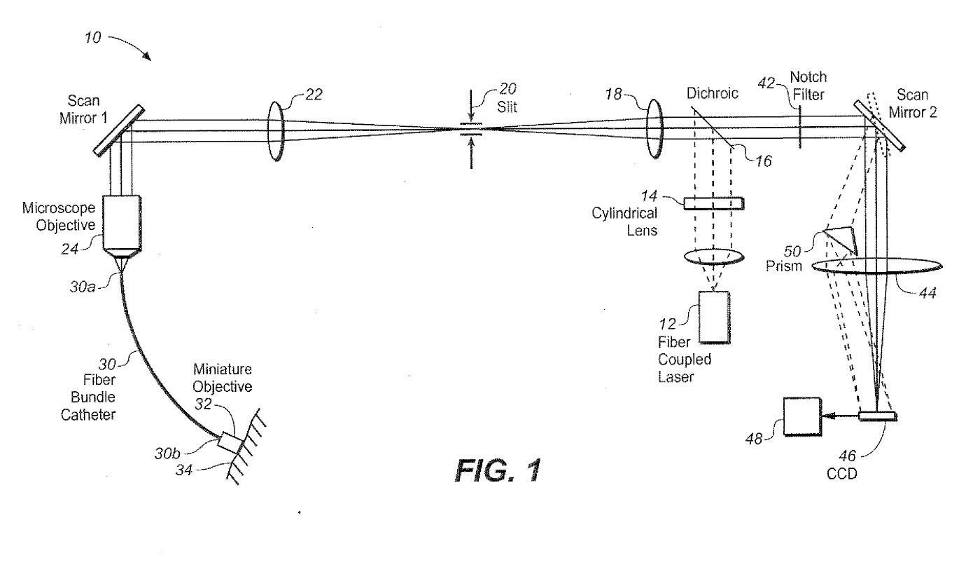

As shown in FIG. 1, light from an excitation source 12 (488 nm laser in the current system) is collimated and passed through a cylindrical lens 14 that has optical power in the direction perpendicular to the plane of the diagram. The excitation light reflects off a dichroic beamsplitter 16 and is focused by a lens 18 onto a slit aperture 20. Another lens 22 and a microscope objective 24 relay the line of illumination to the proximal face 30a of an optical fiber bundle 30. Scan Mirror 1 scans the illumination line across the proximal face of the fiber bundle. The distal end 30b of the catheter or optical fiber bundle is fitted with a custom high NA miniature objective lens 32 that relays the illumination line into the sample 34. Biological samples are topically stained with a fluorescent dye to enhance image contrast. The fluorescence emission from the sample is collected by the system through the same optical train back to the slit 20, which acts as the confocal aperture of the system rejecting light from out-of-focus planes within the sample. The dichroic beamsplitter 16 transmits the longer wavelength fluorescence emission towards the detection arm of the system 10. A notch filter 42 centered on the excitation wavelength further reduces the amount of excitation light entering the detection arm. A second scan mirror 2 reflects the fluorescent signal, which is focused by the camera lens 44 onto a 2D CCD detector 46. Scan Mirror 2, synchronized with Scan Mirror 1, scans the collected fluorescent signal across the CCD detector, yielding at each image pixel a grayscale output, to form a 2D grayscale en face image of the sample. The 2D grayscale en face image of the sample from CCD 46 is processed by a computer 48. Scan mirrors 1 and 2 are rotated by means of one or more motors (not shown) controlled by computer 48 (control lines not shown).

The system is also capable of acquiring multispectral images by tilting Scan Mirror 2 to a fixed off-axis position such that the fluorescence emission is directed through an off-axis prism 50. For each position of Scan Mirror 1, a 2D image is collected consisting of one spatial dimension along the slit and one spectral dimension perpendicular to the slit (along the prism's dispersion direction). Multiple frames of data are collected as Scan Mirror 1 scans the illumination line across the fiber face. Scan Mirror 1 must be slowed down to accommodate the increased data collection time of multiple CCD frames. The frame time is increased by a factor roughly equivalent to the number of spectrally resolved points in the spectral dimension. At the end of a scan cycle, a 3D data cube is obtained that provides a fluorescence spectrum at each 2D spatial location in the sample.

While the fluorescence confocal microendoscope above operates to collect fluorescent emission from the sample, it will be understood that the same instrument may also operate in reflectance mode, where light delivered by the instrument to the sample 34 is reflected by the sample, and the reflected light is collected by the fiber bundle 30 creating the confocal image. Such variations are within the scope of the invention.

A variety of biological tissues have been imaged in both grayscale mode and multispectral mode of operation (human: esophagus, ovary, pancreas; mouse: liver, heart, kidney, peritoneal wall . . . ) and in various settings (in vivo, ex vivo), With appropriate fluorescent dyes, the image results provided by the confocal system allow the visualization of the size and shape of nuclei, the structural organization of cells, as well, as the spectral properties of the imaged sample (different cellular structures have been shown to exhibit variations in spectral emission).

The performance of the confocal microendoscope system is summarized in Table 1.

TABLE 1
Performance of the Multispectral Fluorescence
Confocal Microendoscope

| Characteristic | Value | |
|---|---|---|
| Axial resolution | 25 | μm |
| Lateral resolution | 3 | μm |
| Imaging depth | up to 200 | μm* |
| Field of view | 450 | μm |
| Grayscale mode frame rate | 30 | fps |
| Spectral bandwidth | 500 to 750 | nm |
| Spectral resolution | | |
| @500 nm | 2.9 | nm |
| @700 nm | 8.4 | nm |
| Multispectral acquisition speed | 6 | s |
| (150 spectral samples) | | |

*Depends strongly on tissue type and dye penetration.

### Incorporation of Spectral Domain Optical Coherence Tomography

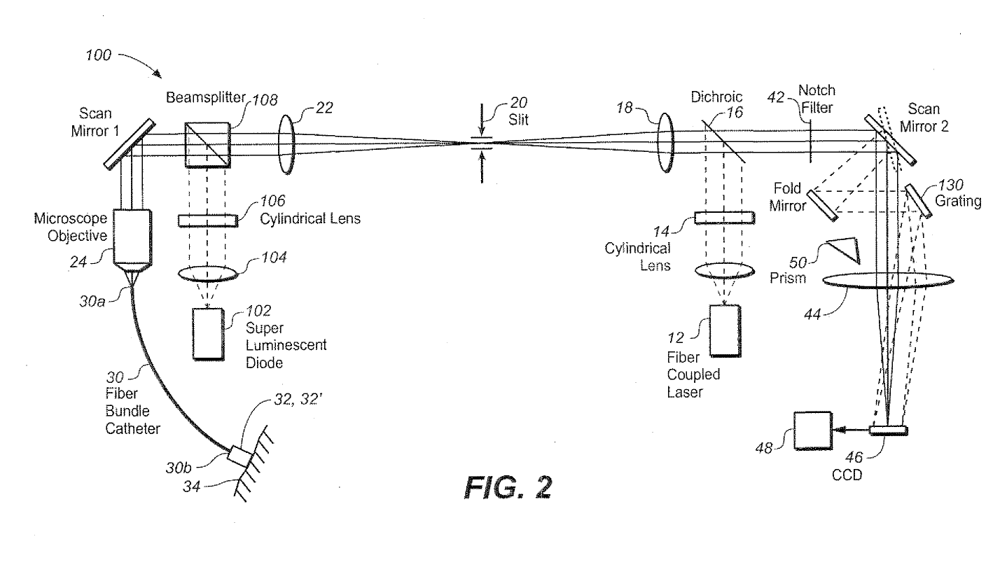

An approach has been developed to include SD-OCT as an additional imaging modality within the confocal microendoscope imaging system in a combined system 100 shown in FIG. 2. Typical SD-OCT systems are point-scan instruments fitted with a grating and a 1D CCD array to make a spectral measurement at each scan point. A single point in the sample is illuminated and an A-scan (depth scan) is reconstructed from the interferogram by a Fourier transform. The illumination point is then scanned in one or two directions across the sample to reconstruct a 2D or 3D OCT image.

The confocal system has been adapted to allow parallel SD-OCT imaging using essentially the same optical train (most importantly the same fiber bundle). A 2D cross-sectional OCT image is produced with no spatial scanning because of the inherent parallelism of the fiber bundle and the illumination along the slit aperture. A 3D OCT image is produced by rotating Scan Mirror 1 while reading out multiple frames of CCD data. The resulting system is a multi-modal instrument that has the potential to be rapidly switched between confocal and OCT modes of operation.

FIG. 2 shows the layout of the multi-modal system 100. The OCT light source 102 is a super luminescent diode (SLD) with a central wavelength of 838 nm and a spectral bandwidth of 24 nm. This source allows a theoretical axial resolution of 12.9 μm based on its coherence length and assuming an ideal Gaussian shape for its power spectrum (see, B. E. Bouma and G. J. Tearney, Handbook of Optical Coherence Tomography, Informa Healthcare, New York, (2001), Chap. 1). As with the confocal system, an anamorphic optical system (including lenses 104, 106) produces a line of illumination on the proximal face 30a of the fiber bundle. In this proof of concept implementation the high NA miniature objective 32 at the distal tip 30b of the catheter was replaced with a back-to-back pair of 10× microscope objectives 32′. An adjustable aperture allowed the illumination NA to be controlled in the 0.05 to 0.22 range. OCT requires a low NA illumination beam (typically 0.1 or less) to increase the depth of field and obtain acceptable image quality. The return light from the sample is collected by the system through the same optical train back to the slit 20. The OCT return light transmitted through the slit is imaged by lenses 18 and 44, and detected by CCD 46 as in the case of the confocal microendoscope sample. For OCT imaging, Scan Mirror 2 is tilted such that the light reflects off a fold mirror to a diffraction grating 130 that disperses the light onto the CCD 46. A 2D cross-sectional OCT image is generated without movement of mirror 1 or 2. A 3D OCT image is generated by scanning Scan Mirror 1 while collecting multiple frames of data from the CCD 46.

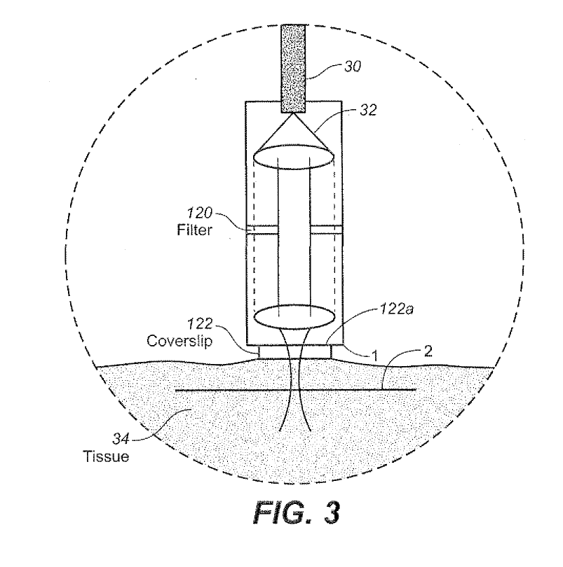

FIG. 3 is a schematic view of a portion of the distal end 30b of the optical fiber bundle in FIG. 2. It is desirable to employ a high NA illumination beam for the confocal microendoscope, and a low NA illumination beam for the OCT. Instead of having to replace the high NA miniature objective 32 at the distal tip 30b with a back-to-back pair of 10× microscope objectives 32′, an annular filter 120 is used together with the high NA miniature objective 32, where the filter blocks only infrared wavelengths of the OCT but passes visible wavelengths in the confocal illumination beam and the returned fluorescence from sample 34 of the confocal microendoscope. In this manner, the infrared beam in the OCT will have a low NA, whereas the visible wavelength beam in the confocal microendoscope will have a high NA. In other words, these light sources in the OCT and the confocal microendoscope are in different spectral ranges (preferably in non-overlapping spectral ranges), which allows aspects of the optical system to be modified based on the spectral regions of operation. The example above is modifying the numerical aperture (NA) of the imaging optics at the distal end 30b of the catheter using a spectral filter that provides a high NA for confocal imaging and lower NA for OCT imaging. A second example would be changing a lens power in different portions of the optical beam and controlling which portions are selected via spectral filters. This can change other optical characteristics of the illumination beam, such as the field of view. There is thus no need to alter the fiber bundle distal end optics when the user switches between using the system as an OCT or as a confocal microendoscope. The only selection the user will need to make is to turn on/off the appropriate light source: laser 12 and SLD 102. The system can thus be rapidly switched between OCT and fluorescence confocal imaging. While in the embodiment above, the OCT employs only infrared wavelengths and the illumination beam and the returned fluorescence from sample 34 of the confocal microendoscope contains only visible wavelengths, this is not required, and other wavelengths (again preferably in non-overlapping spectral ranges) may be used.

In conventional OCT systems with a separate reference arm, the reference arm signal intensity is controlled via the beamsplitter ratio or with a neutral density filter that attenuates light. Reported common-path OCT systems work at a naturally occurring reference reflectivity because an air-glass interface is the reference (˜4% reflectance). In our system, the reference reflectivity can be controlled with a thin film coating of the reference glass plate.

In the prototype system, a total optical power of 190 μW was incident on the sample over the area of the illumination line (˜450 μm×3 μm). A 150 μm thick glass coverslip 122 located at the image plane of the objective assembly was used as the reference reflector with the sample 34 placed in contact behind the coverslip 122. The surface 122a facing the fiber bundle end 30b reflects light which reflected light becomes the reference beam. This reference beam interferes with the return light from the sample. This arrangement yields a common path interferometer (see, A. B. Vakhtin, D. J. Kane, W. R. Wood, and K. A. Peterson, “Common-path interferometer for frequency-domain optical coherence tomography,” Appl. Opt. 42(34), 6953-6958 (2003)) and is less susceptible to the phase instabilities generated in light propagating through a flexible fiber bundle.

This OCT system architecture theoretically enables acquisition of spectral domain optical coherence microscopy (OCM) images, which is another type of implementation of OCT using a high NA objective lens to provide en face images. The coherence gating of light provides the optical sectioning.

The back reflected light from the reference surface 122a and the sample is collected by the system 100. Scan mirror 2 is fixed to an off-axis position to redirect the returning signal light to a 600 lp/mm reflective diffraction grating 130, which disperses the 24 nm wide spectral distribution across the CCD camera 46. For a given position of Scan Mirror 1, an interferogram consisting of one spatial dimension along the illumination line and one spectral dimension in the perpendicular direction is recorded. This is similar to the multispectral confocal mode except that a grating is used rather than a prism 50 in order to achieve the necessary spectral dispersion. The raw data is then processed in computer 48 by taking the Fourier transform to reconstruct a 2D image representing the cross-sectional OCT image of the tissue. Data processing can be done in real-time so that overall OCT image frame rate depends on the camera 46. Operation at 30 frames/s can be done, but the experimental OCT results were obtained with a camera operating at 10 frames/s. Unlike most standard OCT systems, no spatial scanning is required because of the parallel acquisition of spatial information along the slit direction. A 2D data set is collected in a single shot at the frame rate of the CCD camera. It is also possible to collect a 3D OCT image of a sample by rotating Scan Mirror 1 and collecting multiple frames of data from the CCD. Again, this is similar to the multispectral mode of operation of the confocal microendoscope.

A novel architecture combines into a single instrument a fiber-optic multi-modal fluorescence confocal microendoscope and SD-OCT imaging system that rely on different technologies and physical phenomena. The shared optical train concept has the potential for in vivo clinical use and rapid switching between confocal and OCT imaging. Advantages of the OCT setup include the utilization of a fiber-optic bundle amenable to endoscope in situ imaging, a fast parallelized acquisition technique for in vivo imaging, and a common-path interferometer arrangement with no scanning components resulting in a simpler opto-mechanical design.

SD-OCT imaging is implemented as an additional capability in a multispectral fluorescence confocal microendoscope system. The architecture of the combined system is such that the two imaging modalities utilize mostly the same optical components. The SD-OCT modality is enabled by activating an additional source (SLD) and detection pathway (mirror and diffraction grating). The slit-based geometry of the illumination together with the SD-OCT architecture allows for the collection of 2D OCT images at video rates without any scanning. By scanning the illumination line across the sample, a 3D OCT image can be collected. By adjusting the optics in the system 100, it is possible to select the object plane of the confocal microendoscope to be at a selected depth within the object (e.g. tissue) imaged. This image may be compared or correlated with the 3D OCT image at the same depth to yield useful information about the object.

It is expected that in the context of in vivo optical biopsy, confocal imaging and SD-OCT imaging will complement each other by showing different perspectives. High resolution cellular imaging of the tissue surface in an animal body combined with cross-sectional imaging of the tissue structure below the surface offers the potential to evaluate changes related to disease processes, which may ultimately lead to earlier diagnosis and more effective treatment. The fiber bundle 30 can be a rigid or flexible instrument to be used for imaging inside the animal body, where the distal end of the bundle is inserted into the animal body. System 100 has applications to imaging internal organs (e.g. esophagus, stomach, colon, lung, ovary, bladder, uterus). It can be used with unstained tissue or with exogenous contrast agents to enhance visibility of pathology. While embodiments described above relate to endoscopes, it will be understood that system 100 may be used in other applications as well without the fiber bundle 30 for interrogating objects.

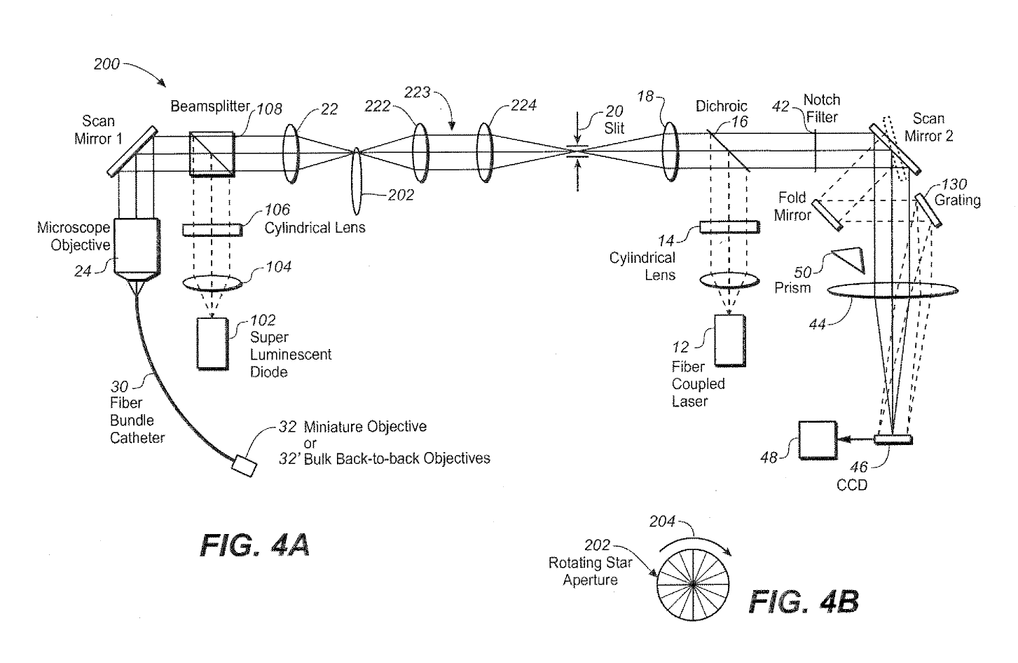

Instead of using a slit 20 as in FIGS. 1 and 2, a multi-point scanning system 200 may be used to scan an array of illumination beams across the sample for both the OCT and confocal microscope. FIG. 4A is a schematic view of a multi-point scanning system 200 employing a rotating star aperture 202 (shown in detail in FIG. 4B) in the optical path of light beams from laser 12 to pass a substantially linear array of illumination beams to the fiber bundle 30. As shown in FIG. 4B, star aperture 202 is rotated along arrow 204. The rotation speed of star aperture 202 is synchronized with the frame rate of the CCD 46. The rotating star aperture 202 may be implemented in a manner similar to that of FIGS. 5A-5D of PCT Publication No. WO 2010/126790, where a stationary slit (not shown in FIGS. 4A, 4B) and a rotating array of radial slits (an implementation of the rotating star aperture 202) superimposed on each other are used to pass light from laser 12 and to provide the substantially linear array of illumination beams. Rotational motion of the radial slits relative to the stationary slit will cause the illumination beams to scan in a direction aligned with the direction of the linear array and of the stationary slit. To build up a 2D image, synchronized scan mirror 1 causes the substantially linear array of illumination beams to scan in a direction transverse (e.g. perpendicular) to the linear array. The star aperture also passes the light returning from the sample (not shown in FIG. 4A) to the CCD 46 to form an image. Scan mirror 2 is scanned in synchrony with scan mirror 1 to produce the 2D image on the CCD. The array of radial slits may be rotated by a conventional means such as a motor (not shown) controlled by computer 48.

While in FIG. 4A only light from laser 12 passes through the star aperture 202, it will be understood that light from the SLD 102 may also be arranged to pass through the aperture 202 to accomplish the multi-point scanning for OCT imaging. This can be arranged by moving the SLD 102, lens 104, cylindrical lens 106, and beamsplitter 108 to the right to locations so that beamsplitter 108 is situated at location 223 in the optical path between lenses 222 and 224, so that light from the SLD 102 will pass through the rotating star aperture 202 towards the sample for illuminating the sample (not shown I FIG. 4A). In this manner, light from SLD 102 will pass through aperture 202 before reaching fiber bundle 30 and the sample. The OCT return light from the sample and bundle 30 will pass through aperture 202 before reaching the CCD 46.

While the invention has been described above by reference to various embodiments, it will be understood that changes and modifications may be made without departing from the scope of the invention, which is to be defined only by the appended claims and their equivalents.

We claim:

1. An endoscope obtaining confocal microscopic and optical coherence tomographic images from an object, comprising:
a confocal microscope;
an optical coherence tomography instrument including a common-path interferometer; and
a fiber bundle delivering to said object illumination light from said confocal microscope and said optical coherence tomography instrument, and collecting return light from the object and delivering the return light to said confocal microscope and said optical coherence tomography instrument.

2. The endoscope of claim 1, wherein said confocal microscope and said optical coherence tomography instrument provide output images that are in two different wavelength ranges.

3. The endoscope of claim 1, wherein said confocal microscope includes a first light source that provides light within a first wavelength range and said optical coherence tomography instrument includes a second light source that provides light within a second wavelength range, wherein said first and second wavelength ranges do not overlap.

4. The endoscope of claim 1, wherein said confocal microscope and said optical coherence tomography instrument include a shared detector and one or more additional shared optical elements.

5. The endoscope of claim 4, wherein said confocal microscope and said optical coherence tomography instrument provide output images that are in two different wavelength ranges, said confocal microscope including a first dispersive element suitable for dispersion in the wavelength range of the output image of the confocal microscope and said optical coherence tomography instrument including a second dispersive element suitable for dispersion in the wavelength range of the output image of the optical coherence tomography instrument.

6. The endoscope of claim 1, wherein said confocal microscope provides at each image pixel a grayscale output in a first mode of operation and a multi-spectral output in a second mode of operation.

7. The endoscope of claim 1, said fiber bundle having a proximal end and a distal end, wherein said common-path interferometer includes a reference surface returning a reference light beam in the interferometer from the distal end of the fiber bundle.

8. The endoscope of claim 1, wherein each of said confocal microscope and said optical coherence tomography instrument illuminates multiple points of a sample and provides outputs indicative of sample properties at said multiple points simultaneously.

9. The endoscope of claim 1, wherein said optical coherence tomography instrument acquires a spectral domain optical coherence microscopic image.

10. A system performing confocal microscopic and optical coherence tomographic functions, comprising:
a confocal microscope including a first light source that provides light within a first wavelength range;
an optical coherence tomography instrument including a second light source that provides light within a second wavelength range, wherein said first and second wavelength ranges are different; wherein said confocal microscope and said optical coherence tomography instrument share an optical element whose optical characteristics are different in said first and second wavelength ranges

11. The system of claim 10, wherein said first wavelength range includes only visible wavelengths and the second wavelength range includes only infrared wavelengths.

12. The system of claim 10, wherein said optical element has two different numerical apertures in said first and second wavelength ranges.

13. The system of claim 10, wherein said optical element includes an annular filter that transmits wavelengths in the first wavelength range, and blocks wavelengths in the second wavelength range.

14. The system of claim 10, wherein one of said confocal microscope and said optical coherence tomography instrument is selectable to be operated at any one time for acquiring images of the object.

15. A system obtaining confocal microscopic and optical coherence tomographic images from a sample, comprising:
a confocal microscope that illuminates multiple points of the sample and provides outputs indicative of sample properties at said multiple points simultaneously; and
an optical coherence tomography instrument that illuminates multiple points of the sample and provides outputs indicative of sample properties at said multiple points simultaneously.

16. The system of claim 15, further comprising a mechanism for causing the confocal microscope and the optical coherence tomography instrument to scan at different times at least one illumination beam for illuminating said multiple points of the sample and provide a three dimensional data output for the optical coherence tomography instrument, and a two dimensional data output for the confocal microscope.

17. The system of claim 15, wherein the optical coherence tomography instrument provides a two dimensional cross-sectional image of the sample without any scanning of the sample.

18. The system of claim 15, wherein the confocal microscope and the optical coherence tomography instrument cause an elongated area of the sample to be illuminated and provide data outputs from light returned from said elongated area.

19. The system of claim 15, wherein the confocal microscope and the optical coherence tomography instrument cause an array of individual spots of the sample to be illuminated and provide data outputs from light returned from said array of individual spots.

20. A method for obtaining confocal microscopic and optical coherence tomographic images, using a confocal microscope and an optical coherence tomography instrument each of which illuminates multiple points of a sample and provides outputs indicative of sample properties at said multiple points simultaneously, said method comprising the steps of:
causing the confocal microscope to scan at least one illumination beam for illuminating multiple points of the sample and providing a two dimensional image from a selected depth in the object;
causing the optical coherence tomography instrument to scan at least one illumination beam for illuminating multiple points of the sample and providing a two dimensional optical coherence microscopy image from said selected depth in the object; and
comparing or correlating the generated two dimensional confocal microscopy and optical coherence microscopy images.

21. A method for obtaining confocal microscopic and optical coherence tomographic images of an object, using a confocal microscope, an optical coherence tomography instrument and a fiber bundle having a distal end and a proximal end, said fiber bundle delivering to said object at its distal end illumination light from said confocal microscope and said optical coherence tomography instrument, and collecting return light from the object and delivering the return light to said confocal microscope and said optical coherence tomography instrument at its proximal end, said method comprising the steps of:
inserting the distal end of the fiber bundle into an animal body;
acquiring a two dimensional image from a selected depth in said animal body using the confocal microscope;
acquiring a two dimensional en face optical coherence microscopy image or cross-sectional optical coherence tomography image from said animal body using the optical coherence tomography instrument; and
comparing or correlating the two dimensional confocal microscopy and optical coherence tomography or optical coherence microscopy images.

22. The method of claim 21, wherein the acquiring of the two dimensional optical coherence microscopy image or optical coherence tomography image using the optical coherence tomography instrument includes using a common path interferometer, and wherein a reference surface in the common path interferometer at the distal end returns a reference beam.
